(19) United States
(12) Patent Application Publication
(10) Pub. No.: US 2021/0270400 A1
(43) Pub. Date: Sep. 2, 2021

(54) LIGHT WALL INTEGRAL NOZZLE

(71) Applicant: FORGED COMPONENTS, INC., Humble, TX (US)

(72) Inventors: David L. Allen, Humble, TX (US); Purav Patel, Humble, TX (US)

(21) Appl. No.: 16/805,173

(22) Filed: Feb. 28, 2020

(51) Int. Cl. F16L 23/026

(52) U.S. Cl. CPC F16L 23/026

(57) ABSTRACT

An integral nozzle with a section of pipe having a weld end and a flange end. Proximate the flange end there can be a thickened section to strengthen and stabilize the integral nozzle. The wall thickness of the section of pipe can be less than a standard size, such as schedule 40 or schedule 80 pipe, thereby reducing the weight, overall circumference of the weld end, and required material to make the integral nozzle.

### FIELD

The present disclosure generally relates to a light wall integral nozzle for use with fluid vessels or any fluid containing equipment.

### BACKGROUND

Often, in industrial applications, connections to fluid vessels or fluid containing equipment are created in the field. This can involve two or more weld points used to connect a section of pipe and a flange. A common connection for such a field construction utilizes a section of straight pipe welded to a flange.

The usage of field constructed connections is generally more cost effective than the purchase and use of an integral connector, such as a forged connection. However, extra weld points can lead to undesirable results, such as weak points that impact safety negatively, decrease equipment longevity/life, and contamination of fluid with weld material.

Additionally, field constructed connections typically have flow constriction at the point of mating, i.e. a flange, due to the use of a straight pipe welded to the flange. This can create turbulence in fluid, reduce the flow rate undesirably, and restrict the insertion of instrumentation.

The present disclosure provides an integral nozzle which addresses the above deficiencies and cost effectively provides a safer and more effective connection usable for fluid tanks to connect to piping, reduces the weld material and labor, and facilitates the use of instrumentation.

### BRIEF DESCRIPTION OF THE DRAWINGS

The detailed description will be better understood in conjunction with the accompanying drawings as follows:

FIG. 1 shows a typical welded connection created in the field.

FIG. 2 depicts a prior art integral connection.

FIG. 3 depicts an embodiment of the present disclosure.

The embodiments of the present disclosure are detailed below with reference to the listed Figures.

### DETAILED DESCRIPTION OF THE EMBODIMENTS

Before explaining the present disclosure in detail, it is to be understood that the disclosure is not limited to the specifics of particular embodiments as described and that it can be practiced, constructed, or carried out in various ways.

While embodiments of the disclosure have been shown and described, modifications thereof can be made by one skilled in the art without departing from the spirit and teachings of the disclosure. The embodiments described herein are exemplary only, and are not intended to be limiting.

Specific structural and functional details disclosed herein are not to be interpreted as limiting, but merely as a basis of the claims and as a representative basis for teaching persons having ordinary skill in the art to variously employ the present embodiments. Many variations and modifications of embodiments disclosed herein are possible and are within the scope of the present disclosure.

Where numerical ranges or limitations are expressly stated, such express ranges or limitations should be understood to include iterative ranges or limitations of like magnitude falling within the expressly stated ranges or limitations.

The use of the word “a” or “an” when used in conjunction with the term “comprising” in the claims and/or the specification may mean “one,” but it is also consistent with the meaning of “one or more,” “at least one,” and “one or more than one.”

The word “about”, when referring to values, means plus or minus 5% of the stated number.

The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

When methods are disclosed or discussed, the order of the steps is not intended to be limiting, but merely exemplary unless otherwise stated.

Accordingly, the scope of protection is not limited by the description herein, but is only limited by the claims which follow, encompassing all equivalents of the subject matter of the claims. Each and every claim is hereby incorporated into the specification as an embodiment of the present disclosure. Thus, the claims are a further description and are an addition to the embodiments of the present disclosure.

The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

The embodiments of the present disclosure generally relate to a light wall integral nozzle for use with fluid vessels or fluid containing equipment. This includes, but is not limited to, fluid tanks, separators, pressure vessels, fluid handling equipment, and the like for gasses and liquids.

The integral nozzle can have a section of pipe with a weld end and a flange end, a thickened section proximate the flange end, and a flange connection formed on the flange end of the section of pipe.

The flange connection can be a standard flange size and comport to various industrial standards, such as ANSI, API, ISO, and the like. For example, the flange can be sized to connect to an ANSI 150 #flange.

In embodiments, the section of pipe can have a wall thickness less than a standard wall thickness. In field fabricated nozzles and connections, a schedule 40 or schedule 80 pipe is typically used. By creating a forged and integral nozzle, the embodiments of the present disclosure can be manufactured with a smaller wall thickness giving the section of pipe a smaller outer diameter. This saves material, making the nozzle lighter and more cost efficient. Furthermore, attachment to the vessel is easier, as there is a smaller weld circumference leading to less weld material and labor for attachment.

The section of pipe can have a thickened section proximate the flange connection, to strengthen the nozzle and provide a stable and robust connection to a pipe. The thickened section can taper from the section of pipe to the flange connection.

Additionally, the section of pipe can have an inner bore less than a standard size inner bore (such as defined by schedule 40 pipe). This allows for the inner bore of the nozzle to match the inner bore of the pipe it is connecting to.

Typical field fabricated connections will have a step down in the inner bore of the fluid flow pathway at the point of connecting flanges. This can create turbulence and an undesired pressure drop or restriction in flow. This can also lead to measurement errors for flow meters or volumetric sensors.

By matching the inner bore of the nozzle with the inner bore of the pipe being connected to, the above deficiencies are cured, making the embodiments of the present disclosure more efficient in operation.

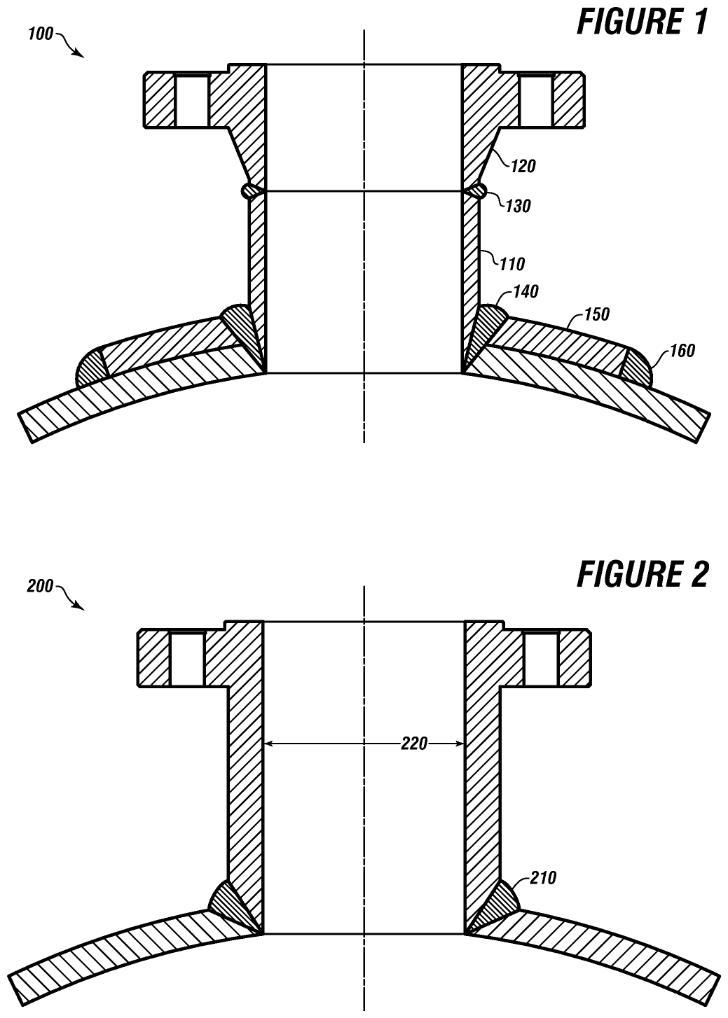

Turning now to the Figures, FIG. 1 shows a typical welded connection created in the field.

The field constructed connection 100, can have a straight pipe 110 and a flange 120 welded to the straight pipe 110 at weld point 130. The connection can be welded to a vessel at second weld point 140. In some applications, it may be necessary to add build up material 150 and a third weld point 160 to strengthen or stabilize the connector.

As each weld point is an inherent weak point in any equipment, this type of connector is undesirable due to safety and maintenance concerns. However, in the current state of the art, this is the most cost-effective solution and is widely implemented in industry.

FIG. 2 depicts a prior art integral connection.

The prior art integral connection 200 can be attached to a vessel or piece of equipment at weld point 210. The bore 220 is typically larger than the pipe it is connected to, leading to turbulence, flow restrictions, or creation of sensor measurement error.

The prior art integral connection 200 can cost from 30% to 120% more than the field constructed connection shown in FIG. 1. While prior art integral connection 200 is safer and easier to maintain, it is not commonly used in industry due to being cost prohibitive, as often hundreds of these connections are required at a single site.

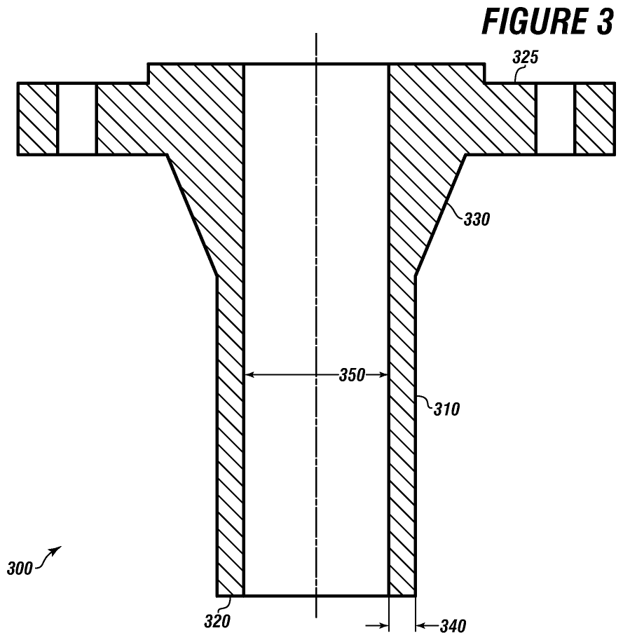

FIG. 3 depicts an embodiment of the present disclosure.

The integral nozzle 300 can comprise a section of pipe 310 having a weld end 320 and a flange end 325. Proximate the flange end 325, there can be a thickened section 330 to strengthen and stabilize the integral nozzle 300. The wall thickness 340 of the section of pipe 310 can be less than a standard size, i.e. schedule 40 or schedule 80 pipe, thereby reducing the weight, overall circumference of the weld end, and required material to make the integral nozzle 300.

The bore 350 of the integral nozzle 300 is smaller than the prior art shown in FIGS. 1 and 2. The bore 350 is matched to pipe being connected to reduce or eliminate turbulence, flow restriction, or sensor measurement error at the connection.

Flange end 325 can be sized and dimensioned to industry standards, such as ANSI, API, Iso, etc. This allows for connection or mating to standard flanges used at a facility.

The embodiments of the present disclosure can therefore be approximately the same cost as the field constructed connection 100, or even cost less in many instances. This encourages the adoption of embodiments of the present disclosure, thereby promoting safety, equipment longevity, and reduced maintenance costs.

While the present disclosure emphasizes the presented embodiments and Figures, it should be understood that within the scope of the appended claims, the disclosure might be embodied other than as specifically enabled herein

What is claimed is:

1. An integral nozzle comprising:
a. a section of pipe with a weld end and a flange end;
b. a thickened section proximate the flange end; and
c. a flange connection formed on the flange end of the section of pipe.

2. The integral nozzle of claim 1, wherein the flange connection is a standard flange size.

3. The integral nozzle of claim 1, wherein the flange connection comports to ANSI standards.

4. The integral nozzle of claim 2, wherein the section of pipe has a wall thickness less than a standard wall thickness.

5. The integral nozzle of claim 3, wherein the section of pipe has a wall thickness less than an ANSI standard wall thickness.

6. The integral nozzle of claim 1, wherein the thickened section tapers from the flange connection to the section of pipe.
